(19) United States
(12) Patent Application Publication
(10) Pub. No.: US 2011/0202886 A1
(43) Pub. Date: Aug. 18, 2011

(54) SYSTEM AND METHOD FOR DISPLAYING DOCUMENTS

(76) Inventors: Vinay Deolalikar, Cupertino, CA (US); Alistair Veitch, Mountain View, CA (US); Hernan Laffitte, Mountain View, CA (US); Ixai Lanzagorta Ochoa, Zapopan (MX); Charles B. Morrey, III, Palo Alto, CA (US)

(21) Appl. No.: 12/705,585

(22) Filed: Feb. 13, 2010

(51) Int. Cl. G06F 3/048

(52) U.S. Cl. 715/853

(57) ABSTRACT

A computer system that includes a graphical user interface used to organize a group of documents is provided. The system includes a processor that is adapted to execute machine-readable instructions. The system also includes a storage device that is adapted to store data. The data includes a plurality of documents and instructions that are executable by the processor to generate the graphical user interface. The graphical user interface includes a cluster map that includes the results of a clustering algorithm applied to the documents. The graphical user interface also includes a principal documents screen that includes a principal document that is identified by weighting each of the documents in a cluster based, at least in part, on an occurrence of representative terms in the document. The representative terms are terms that have been identified by the clustering algorithm as being more effective for distinguishing between documents that belong to different clusters.

### BACKGROUND

Managing large numbers of electronic documents in a data storage system can present several challenges. A typical data storage system may store thousands or even millions of documents, many of which may be related in some way. For example, in some cases, a document may serve as a template which various people within the enterprise adapt to fit existing needs. In other cases, a document may be updated over time as new information is acquired or the current state of knowledge about a subject evolves. In some cases, several documents may relate to a common subject and may borrow text from common files. It may sometimes be useful to be able to trace the evolution of a stored document. However, it will often be the case that the documents in the data storage system have been duplicated and edited over time without keeping any record of prior versions of the document.

### BRIEF DESCRIPTION OF THE DRAWINGS

Certain exemplary embodiments are described in the following detailed description and in reference to the drawings, in which:

FIG. 1 is a block diagram of a computer network 100 in which a client system can access a data storage system, in accordance with an exemplary embodiment of the present invention;

FIG. 2 is a screen shot of an initial document selection screen for a document analysis graphical user interface (GUI), in accordance with an exemplary embodiment of the present invention;

FIG. 3 is a screen shot of a document collection progress screen for a document analysis GUI, in accordance with an exemplary embodiment of the present invention;

FIG. 4 is a screen shot of a document cluster screen for a document analysis GUI, in accordance with an exemplary embodiment of the present invention;

FIG. 5 is a screen shot of a cluster description screen for a document analysis GUI, in accordance with an exemplary embodiment of the present invention;

FIG. 6 is a screen shot of a document description screen for a document analysis GUI, in accordance with an exemplary embodiment of the present invention;

FIG. 7 is a screen shot of a document provenance screen for a document analysis GUI, in accordance with an exemplary embodiment of the present invention;

FIG. 8 is a screen shot of a document freshness screen for a document analysis GUI, in accordance with an exemplary embodiment of the present invention;

FIG. 9 is a screen shot of a document summary screen for a document analysis GUI, in accordance with an exemplary embodiment of the present invention;

FIG. 10 is a screen shot of a principal documents screen for a document analysis GUI, in accordance with an exemplary embodiment of the present invention;

FIG. 11 is a process flow diagram of a method for displaying related groups of documents, in accordance with an exemplary embodiment of the present invention; and

FIG. 12 is a block diagram showing a tangible, machine-readable medium that stores code adapted to generate a document analysis GUI, in accordance with an exemplary embodiment of the present invention.

### DETAILED DESCRIPTION

Exemplary embodiments of the present invention provide techniques for enabling a user to process a large number of files, termed “documents,” in a data storage system, locate documents of interest, and find and view documents that are related to a selected document, even if a record of a relationship has not been maintained. A graphical user interface (GUI) allows a user to select a group of documents for the analysis. In an exemplary embodiment, the selected documents may be grouped into clusters based on a similarity of the terms used in the documents. The GUI enables a user to select one or more of the clusters and view a number of documents, termed “principal documents,” which have been automatically identified as being more relevant documents in the cluster, according to the clustering parameters identified by the clustering algorithm. Documents presented by the GUI may be selected by a user for further analysis, including, but not limited to, a summary of the document's content, the evolution of the document from source documents, and newer documents that may have been generated using the document. In this way, the GUI enables the user to quickly and easily locate relevant documents within a large collection of unstructured documents and view the content and evolution of those documents. As used herein, the term “automatically” is used to denote an automated process performed without human intervention, for example, processes executed by a machine such as the computer device 102. It will be appreciated that various processing steps may be performed automatically even if not specifically referred to herein as such.

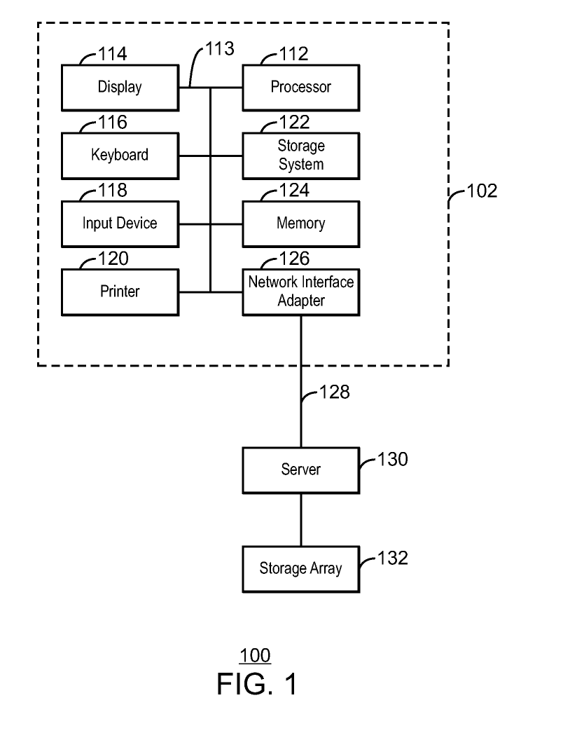

FIG. 1 is a block diagram of a computer network 100 in which a client system 102 can access a data storage system, in accordance with an exemplary embodiment of the present invention. As illustrated in FIG. 1, the client system 102 will generally have a processor 112, which may be connected through a bus 113 to a display 114, a keyboard 116, and one or more input devices 118, such as a mouse or touch screen. The client system 102 can also have an output device, such as a printer 120 connected to the bus 113.

The client system 102 can have other units operatively coupled to the processor 112 through the bus 113. These units can include tangible, machine-readable storage media, such as a storage system 122 for the long-term storage of operating programs and data, including the programs and data used in exemplary embodiments of the present techniques. The storage system 122 may include, for example, a hard drive, an array of hard drives, an optical drive, an array of optical drives, a flash drive, or any other tangible storage device. Further, the client system 102 can have one or more other types of tangible, machine-readable storage media, such as a memory 124, for example, which may comprise read-only memory (ROM) and/or random access memory (RAM). In exemplary embodiments, the client system 102 will generally include a network interface adapter 126, for connecting the client system 102 to a network, such as a local area network (LAN 128), a wide-area network (WAN), or another network configuration. The LAN 128 can include routers, switches, modems, or any other kind of interface device used for interconnection.

Through the LAN 128, the client system 102 can connect to a server 130. The server 130 can have a storage array 132 for storing enterprise data. The enterprise data may include a plurality of documents, for example, PDF documents, spreadsheets, presentation documents, word processing documents, database files, Microsoft® Office documents, Web pages, HTML documents, XML documents, plain text documents, e-mails, optical character recognition (OCR) transcriptions of scanned physical documents, and the like. Furthermore, the documents may be structured or unstructured. As used herein, a set of “structured” documents refers to documents that have been related to one another by a tracking system that records the evolution of the documents from prior versions. However, in embodiments in which the documents are structured, the recorded relationship between documents may be ignored.

Those of ordinary skill in the art will appreciate that business networks can be far more complex and can include numerous servers 130, client systems 102, storage arrays 132, and other storage devices, among other units. Moreover, the business network discussed above should not be considered limiting as any number of other configurations may be used. Any system that allows the client system 102 to access a document storage device should be considered to be within the scope of the present techniques.

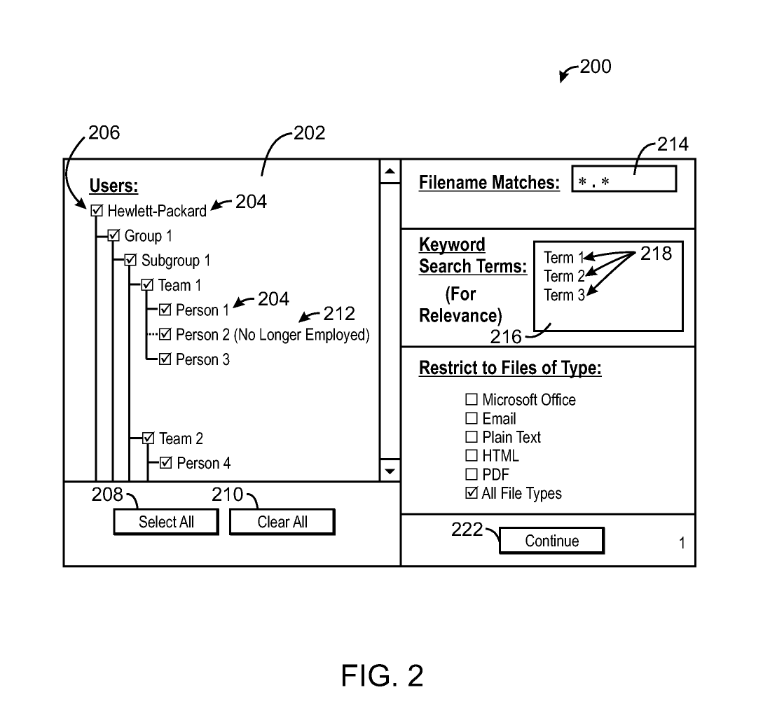

In exemplary embodiments of the present invention, the client system 102 may include a document analysis tool for analyzing electronic documents, for example, documents stored on the storage system 122, storage array 132, or any other storage device accessible to the client system 102. As described further below, the document analysis tool may be used to identify similarities between the electronic documents and the similarities may be used to identify an evolutionary chain between documents. Additionally, the document analysis tool may be used to identify one or more principal documents. The document analysis tool may include a document analysis GUI, which is described below in relation to FIGS. 2-10.

FIG. 2 is a screen shot of an initial document selection screen for a document analysis GUI, in accordance with an exemplary embodiment of the present invention. The document selection screen 200 may enable a user to provide a selection criteria used to identify documents for inclusion in the collection of documents, which may be analyzed in accordance to present techniques. The document selection screen 200 may include a selection window 202 that enables the user to select one or more document authors. For example, the selection window 202 may include an organizational chart showing employees of a company. The documents generated by the selected authors may be included in the collection of documents. The selection window 202 may include one or more author names 204 displayed in a tree hierarchy. Each author name 204 in the tree may be associated with a corresponding checkbox 206 that enables the user to select the author name 204 for inclusion in the collection of documents. Further, the folder selection window 202 may also include a “select all” button 208 for selecting all of the author names 204 displayed in the folder selection window 202 and a “clear all” button 210 for unselecting all of the author names 204 displayed in the author selection window 202. Additionally, the author names 204 may include notations 212, for example, notations indicating that a particular document author is no longer employed by the organization.

In some exemplary embodiments, the document selection screen 200 may include a folder selection window (not shown) that enables the user to select one or more folders corresponding to locations within a directory. The documents within the selected folders may be included in the collection of documents. The folder selection window 202 may include one or more folders displayed in a tree hierarchy. Each folder in the tree may be associated with a corresponding checkbox 206 that enables the user to select the folder for inclusion in the collection of documents.

The document selection screen 200 may include a filename selection window 214 that enables the user to restrict the collection of documents to those documents with a specified filename or filename element, such as a specific filename extension. The filename selection window 214 may enable the user to enter a wildcard character to allow some variation in the filenames of the documents that match the specified filename.

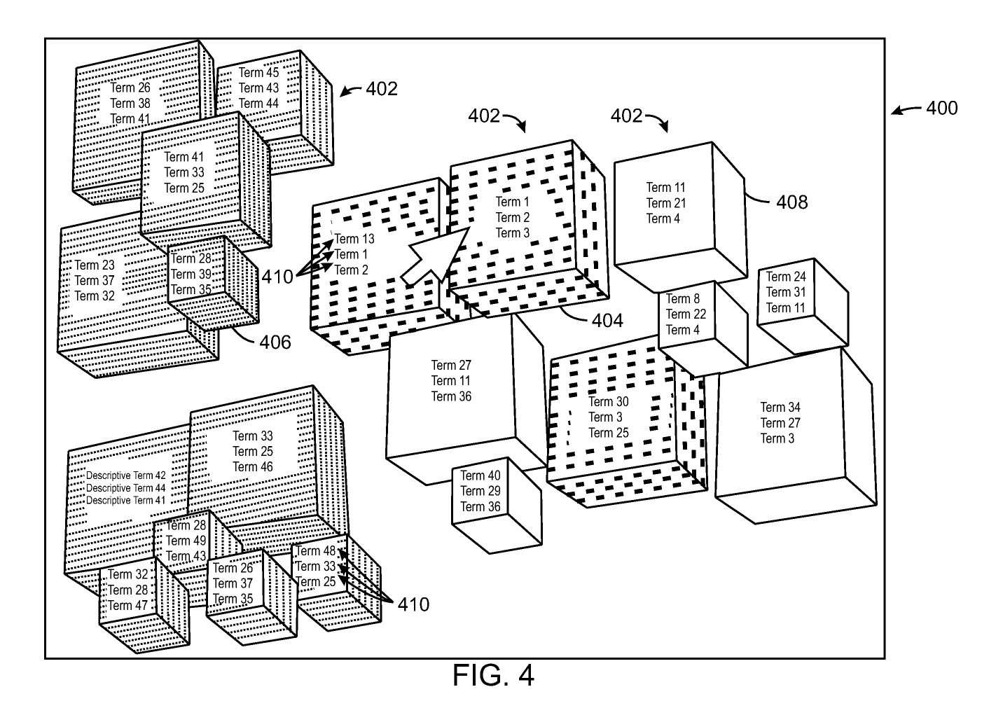

In some exemplary embodiments, the document selection screen 200 includes a keyword entry box 216. The keyword entry box enables the user to enter one or more keywords 218 that represent the subject matter that the user is interested in locating. The keywords 218 may represent words that the user would expect to find in the documents of interest to the user. The keywords 218 may be used to generate a relevance value for each document cluster as described below in relation to FIG. 4.

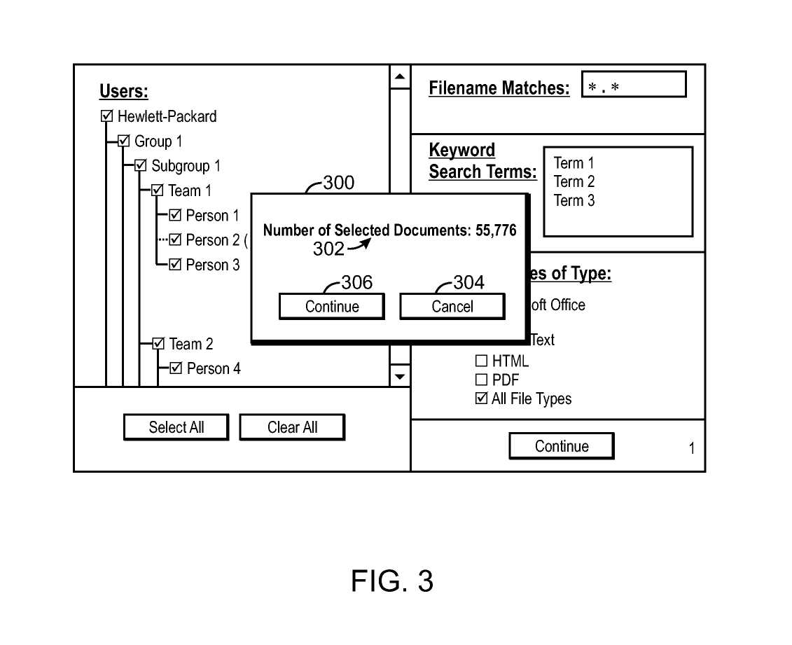

In some exemplary embodiments, the document selection screen 200 includes a file type selection box 220 that enables the user to restrict the collection of documents to those documents of a specified file type, for example, Microsoft® Office documents, e-mails, plain text documents, HTML documents, PDF documents, Web pages, and the like. Additionally, the file type selection box 220 may provide an option by which the user may select all file types for inclusion in the document analysis. In some embodiments, the document selection screen 200 may include other document selection tools. For example, the document selection screen 200 may include document selection tools that enable the user to select documents based on any type of metadata that may be associated with the document, for example, file size, file dates, and the like. After specifying the selection criteria, the user may select a “continue” button 222 to advance to the next screen shown in FIG. 3.

FIG. 3 is a screen shot of a document collection progress screen for a document analysis GUI, in accordance with an exemplary embodiment of the present invention. The document collection progress screen 300 may enable a user to view the progress of a document collection algorithm that adds new documents to the collection based on the selection criteria chosen by the user in the document selection screen 200. The progress screen 300 may include a progress meter 302 that displays the number of documents added to the collection of documents. Furthermore, the progress meter 302 may be periodically updated to show a running total as new documents are added to the collection. During the execution of the document collection algorithm, the user may select a “cancel” button 304. For example, the user may select the cancel button if the user decides that the number documents indicated by the progress meter 302 is too large. Upon selecting the “cancel” button 304 the user may be returned the document selection screen 200, and if the document collection algorithm is still running it may be may be aborted. After the document collection algorithm has finished, the user may select a continue button 306 to advance to the next screen shown in FIG. 4.

FIG. 4 is a screen shot of a document cluster screen for a document analysis GUI, in accordance with an exemplary embodiment of the present invention. The document cluster screen 400 may include a visual representation of the results of a clustering algorithm applied to the documents selected by the user via the document selection screen 200. The clustering algorithm may be used to segment the group of selected documents into a plurality of clusters based on a similarity of the terms that occur in the documents, with similar documents being grouped into the same cluster. For each document, the clustering algorithm may generate a feature vector that may be used to compare documents and identify similarities or dissimilarities between documents. The feature vector may be generated by scanning the document and identifying the individual terms or phrases, referred to herein as “tokens,” occurring in the document. Each time a token is identified in the document, a bit in the feature vector corresponding to the token may be incremented. The feature vectors may then be used by the clustering algorithm to segment the selected documents into a plurality of clusters based on a similarity or dissimilarity of the feature vectors. In exemplary embodiments, the clustering algorithm generates a list of representative terms of each cluster. As used herein, a “representative term” is a term that has been identified by the clustering algorithm to be more effective for distinguishing between documents that belong to different clusters.

Any suitable data mining algorithm may be used to group the selected documents into clusters, for example, a k-means algorithm, repeated bisection algorithm, spectral clustering algorithm, agglomerative clustering algorithm, and the like. These techniques may be considered as either additive or subtractive. The k-means algorithm is an example of an additive algorithm, while a repeated-bisection algorithm may be considered as an example of a subtractive algorithm.

In a k-means algorithm, a number, k, of the documents may be randomly selected by the algorithm. Each of the k documents may be used as a seed for creating a cluster and serve as a representative document for the cluster until a new document is added to the cluster. Each of the remaining documents may be sequentially analyzed and added to one of the clusters based on a similarity between the document and the representative document of the cluster. Each time a new document is added to a cluster, the representative document may be updated by averaging the current representative document with the newly added document, for example, averaging the feature vectors of the documents.

In a repeated-bisection algorithm, the documents may be initially divided into two clusters based on dissimilarities between the documents. Each of the resulting clusters may be further divided into two clusters based on dissimilarities between the documents. The process may be repeated until a final set of clusters is generated.

After generating the document clusters, a visual representation of the document clusters may be generated as shown in the exemplary document cluster screen 400. The visual representation of the document clusters may be referred to as a “cluster map.” The document cluster screen 400 may include a plurality of cluster boxes 402, each of which represents a single cluster generated by the clustering algorithm. Various visual attributes of the cluster boxes 402 may be used to convey characteristics of the corresponding cluster. In one embodiment, the cluster boxes 402 may be sized according to the number of documents included in the cluster. In this case, clusters with larger numbers of documents may be represented by larger cluster boxes 402 and vice versa. Furthermore, the proximity of the cluster boxes 402 within document cluster screen 400 may convey a level of similarity between the clusters. In this case, clusters that are more similar may be positioned closer to each other and clusters that are less similar may be positioned further away from each another.

Additionally, the cluster boxes 402 may be color coded according to the relevance value associated with each document cluster. The relevance value may be used to visually flag those document clusters that may be of greater interest to the user. As noted above in relation to FIG. 2, the relevance values may be generated based, at least in part, on the keywords provided by the user at the document selection screen 200. In one exemplary embodiment, the documents of each cluster are searched to identify the keywords. Each time a keyword is found within a particular document, the relevance value for the corresponding cluster may be increased, for example, incremented. After computing a relevance value for each cluster, the clusters may be ranked according to the relevance value. In some embodiments, each cluster may be assigned one of two or more possible rankings and the cluster boxes 402 may be colored according to the ranking. In some embodiments, each cluster may be assigned one of three possible rankings corresponding with a high degree of relevance, an intermediate degree of relevance, or a low degree of relevance. For example, high relevance cluster boxes 404 may be colored green, intermediate cluster boxes 408 may be colored yellow, and low relevance cluster boxes 406 may colored red. In other embodiments, a greater number of rankings may be used, and a gradual continuum of different colors may be used to represent the rankings.

Additionally, the brightness of the color associated with a specific cluster box may be determined based on a cluster quality value associated with the cluster. The cluster quality for a specific cluster may be computed as the average internal similarity of documents within the cluster minus average external similarity to documents outside the cluster. In some embodiments, the color of each cluster may be determined based on both the relevance value associated with the cluster and the cluster quality value associated with the cluster. For example, clusters with a high relevance value may be colored green. Among green-colored clusters, the clusters that have a higher cluster quality value will have a brighter hue, and the clusters that have a lower cluster quality value will have a paler hue.

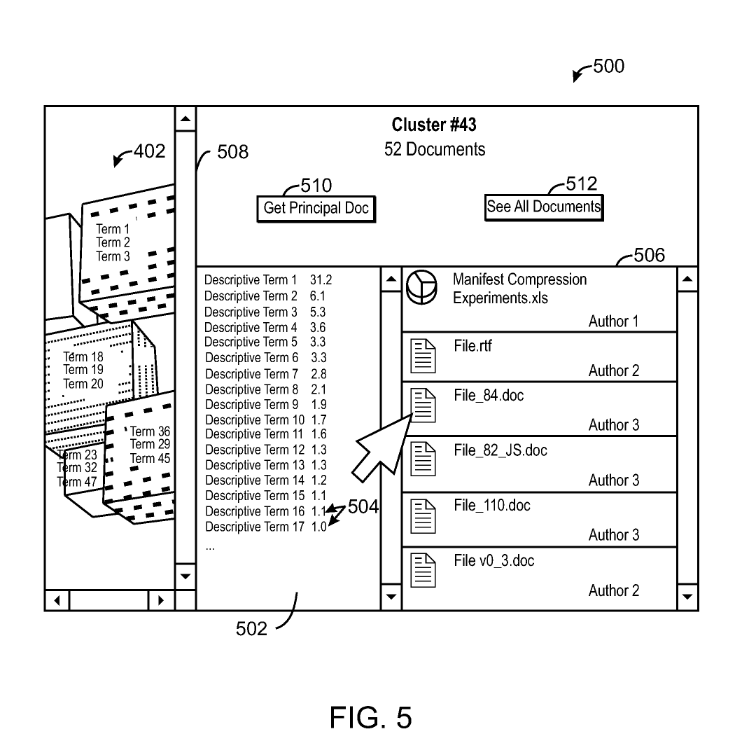

The cluster boxes 402 may also include a textual description 410 of each of the cluster boxes 402. In some embodiments, the textual description 410 may include one or more of the representative terms generated by the clustering algorithm. As noted above, the representative terms may provide an indication of the terms that were used by the clustering algorithm to generate each cluster. In this case, the representative terms shown with a particular cluster box 402 may be terms that often occur within the corresponding cluster, but may not often occur within other clusters. Thus, displaying the representative terms may enable the user to more easily identify clusters of interest. Upon selecting one of the clusters displayed in the document cluster screen 400, the GUI may advance to a cluster description screen, as shown in FIG. 5.

FIG. 5 is a screen shot of a cluster description screen for a document analysis GUI, in accordance with an exemplary embodiment of the present invention. The cluster description screen 500 may display various characteristics of the cluster selected in the document cluster screen 400. For example, the cluster description screen 500 may include a representative term list 502 that lists some or all of the representative terms generated by the clustering algorithm. The representative term list 502 may also include a label 504 that displays a value corresponding with the prevalence of the representative term within the cluster. For example, the label 504 may display a number of times that each representative term occurs in the cluster. In other embodiments, the label 504 may display an average number of times that the representative term occurs across all of the documents in the cluster. The cluster description screen 500 may also include a document list 506 that displays information about some or all of the documents that are included in the cluster, for example, the document name, author name, and the like.

The cluster description screen 500 may also include a cluster view window 508. The cluster view window 508 may provide a graphical view of the cluster map as described in reference to the document cluster screen 400 of FIG. 4. The cluster view window 508 may be scrolled or dragged to change the view of the cluster map or to vary the portion of the cluster map that is viewable in the cluster view window 508. Furthermore, a new cluster may be selected from the cluster view window 508. If the user selects one of the cluster boxes 402 from within the cluster view window 508, the cluster description screen 500 may be updated to describe the cluster corresponding with the newly selected cluster box 402.

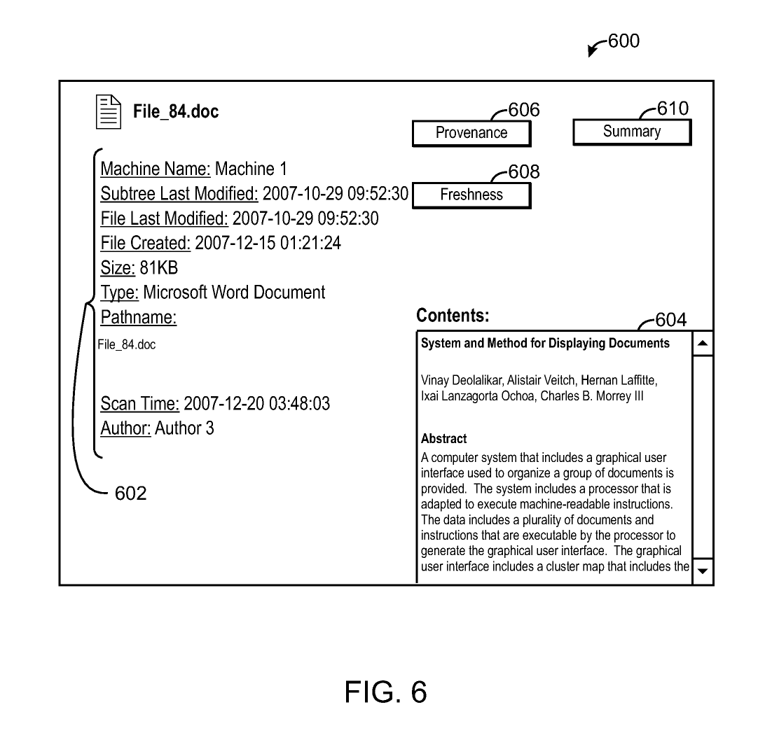

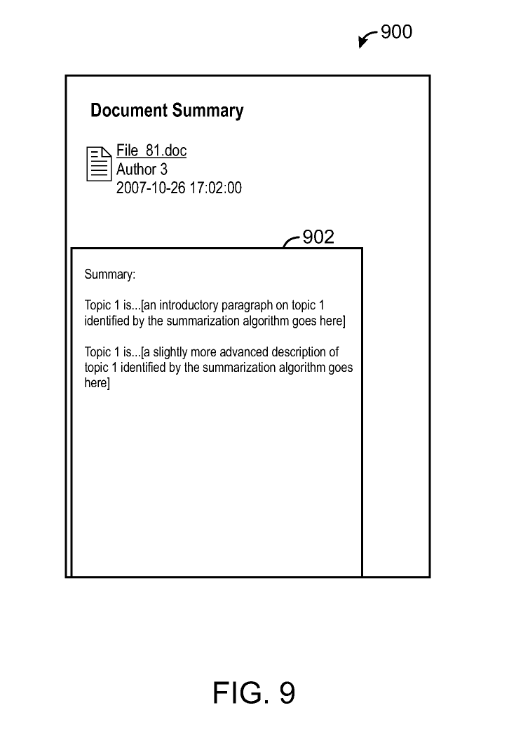

The cluster description screen 500 may also include a “Get principal Documents” button 510 and a “See All Documents” button 512. If the user selects the “Get Principal Documents” button 510 from the cluster description screen 500, the GUI may display information about a subset of documents within the cluster that have been identified by the clustering algorithm as being representative of the cluster, as described below in reference to FIG. 9. Upon selecting a particular document from the document list 506, the GUI may advance to a document description as shown in FIG. 6.

FIG. 6 is a screen shot of a document description screen for a document analysis GUI, in accordance with an exemplary embodiment of the present invention. The document description screen 600 may include a file data section 602 that provides a description of various file characteristics of the document. For example, the file data section 602 may include the name of a machine on which the document is stored and a pathname corresponding to a storage location of the document. The file data section 602 may also include various dates associated with the document such as a date that the document was created, modified, and the like. The file data section 602 may also include other information about the document, such as the size of the document, the document type, document author, and the like. The file data section 602 may also include a scan time for the document and a date and time that the subtree corresponding to the document was last modified. Some or all of the information in the file data section 602 may be obtained from metadata associated with the document.

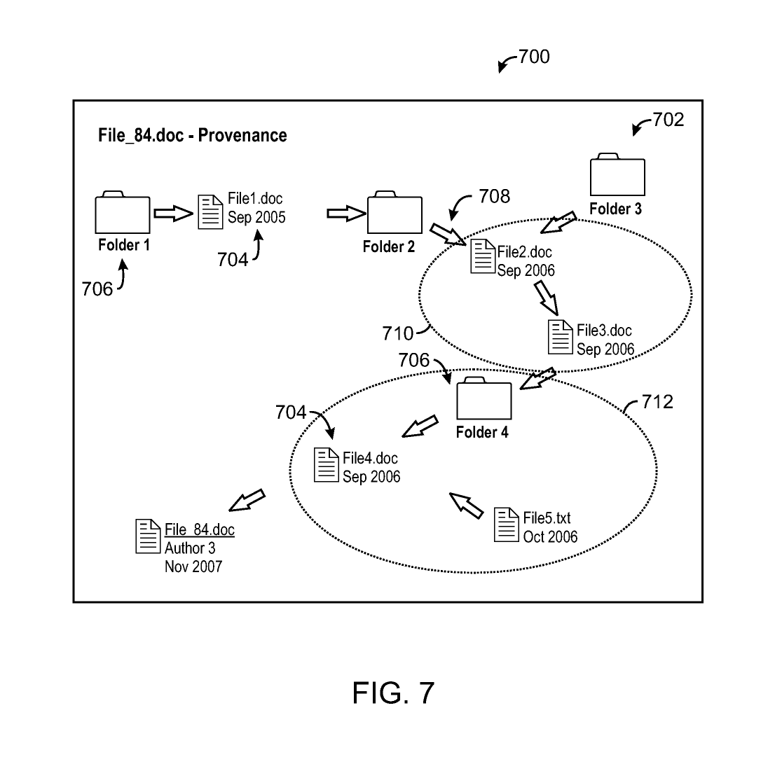

The document description screen 600 may also include a content window 604 that shows the content of the document. The content displayed in the content window 604 may be the textual content that would be displayed to the user upon opening the document in the viewing program applicable to the document. In some exemplary embodiments of the present invention, the user may be able to utilize various document analysis features from the document description screen 600. For example, the document description screen 600 may include a “Provenance” button 606, a “Freshness” button 608, and a “Summary” button 610. The analysis tools corresponding to buttons 606, 608, and 610 are described below in relation to FIGS. 7-9. For example, upon selecting the “Provenance” button 606, the GUI may display a screen showing the provenance of a selected document as shown in FIG. 7. The provenance screen displays older documents that may have contributed content to the selected document.

FIG. 7 is a screen shot of a document provenance screen for a document analysis GUI, in accordance with an exemplary embodiment of the present invention. The document provenance screen 700 may include a visual representation of the results of a provenance algorithm applied to the document selected at the cluster information screen of FIG. 5. The provenance algorithm may analyze documents in the same cluster as the selected document to identify a chain of evolution of the selected document from its origins to its current state. In an exemplary embodiment, the provenance algorithm compares the feature vectors generated by the clustering algorithm for each of the documents to generate a smaller document cluster, referred to herein as a provenance cluster. A cluster granularity may be specified such that all documents that lie within a specified angle of the selected document's feature vector, for example, that have a specified degree of relatedness, may be grouped into the provenance cluster. The resulting provenance cluster may include the selected document and any other documents that have a high degree of similarity with the selected document.

A high degree of similarity of the documents in the provenance cluster may indicate a likelihood that older documents in the provenance cluster contributed to the content of the newer documents. For example, older documents may have contributed content to newer documents in the sense that text may have been copied from the older document to the newer document or the older document may have been edited and renamed to create the newer document. Additionally, an older document may have contributed content to a newer document in the sense that the older document may have played a role in the thought process that led to the creation of the newer document.

After generating the provenance cluster, the provenance algorithm may order the documents within the provenance cluster according to a date or time associated with each document. For example, the time may be a time that the document was created, last modified, and the like. The ordering of the documents may be used to identify relationships between the documents. For example, if a document X precedes a document Y, document Y may be identified as an edited version of document X and document Y may be identified as a derivation of document X.

In some exemplary embodiments, the provenance algorithm may be used to iteratively obtain the provenance for each document in the original provenance cluster. In this case, the original provenance cluster may be referred to as a primary provenance cluster and each document in the primary provenance cluster may be used to generate a set of secondary provenance clusters. The process may be re-iterated to identify tertiary provenance clusters, and so on until all of the documents in a chain have been identified. Those documents within a same cluster may be identified as belonging to a chain of document edits. If documents contained within separate clusters have a common successor, the documents in the separate clusters may be identified as having been merged into the common document, and we may be able to infer, using data mining on the directory paths, that the corresponding projects have merged into a later common project.

After generating the clusters and ordering the documents, the provenance clusters may be used to generate a provenance map 702. The provenance map 702 may include a visual representation of the documents in the provenance clusters, which may be spatially organized based on the identified relationships between the documents, for example, whether a document has been identified as an edit of an older document or a merger of two or more older documents. The provenance map 702 may include file icons 704 to identify the documents in the provenance clusters. The file icons 704 may include a file name and other information about the document, for example, a date that the document was created or last modified. The provenance map 702 may also include folder icons 706 used to identify the location of the documents. The folder icons 706 may include a name of the folder as well as other information about the folder, for example, a name of a computer on which the folder is stored. The provenance map 702 may also include arrows 708 for illustrating the relationships between the documents and folders. A file edit may be indicated when a file icon 704 is directly linked by an arrow 708 to a single older file icon 704. A file merger may be indicated when a file icon 704 is directly linked by more than one arrow 708 to more than one older file icon 704. The last document in the chain may be the selected document, which is shown in FIG. 7 as the document with the filename “file_{—}84.doc.”

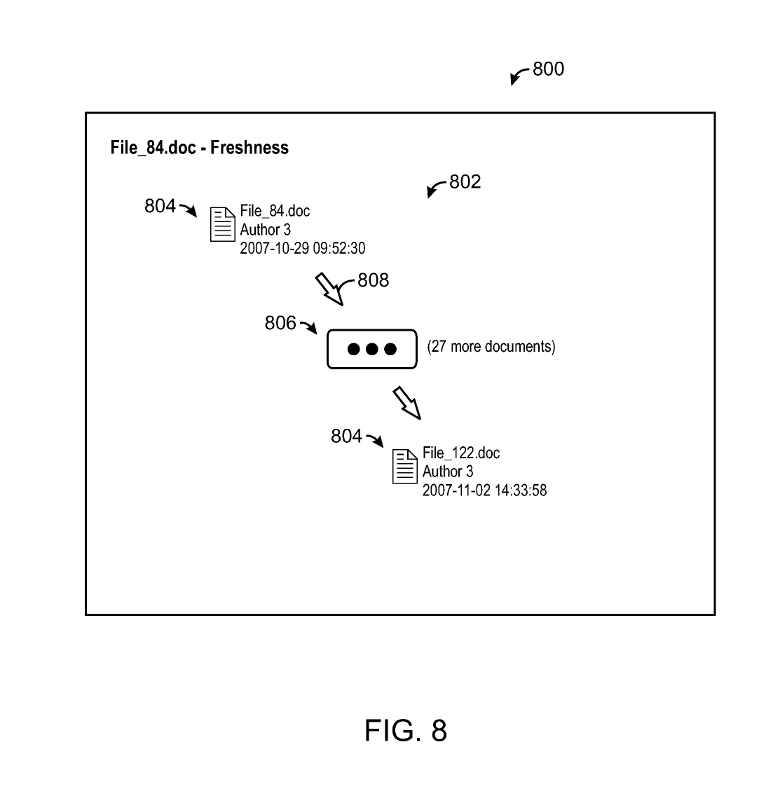

In some exemplary embodiments, the user may click on the file icons 704 and folder icons 706 to obtain additional information about the corresponding folder or document. For example, clicking on a file icon 704 may cause the GUI to return to the document information screen 600, wherein information about the newly selected document may be displayed. Upon selecting the “Freshness” button 608 shown in FIG. 6, the GUI may display a screen showing the freshness of a selected document as shown in FIG. 8. The freshness screen displays newer documents that may be newer versions of the selected document.

FIG. 8 is a screen shot of a document freshness screen for a document analysis GUI, in accordance with an exemplary embodiment of the present invention. The document freshness screen 800 may include a visual representation of the results of a freshness algorithm applied to the document selected at the cluster information screen of FIG. 5. The freshness algorithm may analyze documents in the same cluster as the selected document to identify newer documents in the cluster that may be derivatives of the selected document. In an exemplary embodiment, the freshness algorithm compares the feature vectors generated by the clustering algorithm for each of the documents to generate a smaller document cluster, referred to herein as a freshness cluster. A cluster granularity may be specified such that all documents that lie within a specified angle of the selected document's feature vector may be grouped into the freshness cluster. The resulting freshness cluster may include the selected document and any other documents that have a high degree of similarity with the selected document. The high degree of similarity of the documents in the freshness cluster may indicate a high degree of likelihood that newer documents in the freshness cluster may have been derived from the older documents.

After generating the freshness cluster, the freshness algorithm may order the documents within the freshness cluster according to a date or time associated with each document. For example, as noted above, the time may be a time that the document was created, last modified, and the like. The document order may be used to identify documents that are associated with a later date or time compared to the selected document. Documents that precede the selected document may be ignored, while documents that follow the selected document may be ordered according to date.

In some exemplary embodiments, the freshness algorithm may be used to iteratively obtain the freshness for each document in the original freshness cluster. In this case, the original freshness cluster may be referred to as a primary freshness cluster and each document in the primary freshness cluster may be used to generate a set of secondary freshness clusters. The process may be re-iterated to identify tertiary freshness clusters, and so on until all of the documents in a chain have been identified. Those documents within a same cluster may be identified as belonging to a chain of document edits.

After generating the freshness cluster and ordering the documents, the freshness cluster may be used to generate a freshness map 802. The freshness map 802 may include a visual representation of some or all of the documents in the freshness clusters, which may be spatially organized based on the identified relationships between the documents, for example, whether a document has been identified as an edit of an older document. The freshness map 802 may include file icons 804 to identify the documents in the freshness clusters. The file icons 804 may include a file name and other information about the document, for example, a date that the document was created or last modified. In some exemplary embodiments, the freshness map 802 may also include folder icons used to identify the location of the documents. The documents displayed in the freshness map 802 may be linked in chain by arrows 808, which may be used to illustrate the relationships between the documents. For example, a file edit may be indicated when a file icon 804 is directly linked by an arrow 808 to a newer file icon 804. The first document in the chain may be the selected document, which is shown in FIG. 8 as the document with the filename “file_{—}84.doc.”

Furthermore, if a large number of documents are included in the freshness clusters, the freshness map 802 may include a group icon 806, which may be used to represent a group of documents. In some exemplary embodiments, the user may click on the group icon 806 to obtain additional information about the documents represented by the group icon 806. The last document in the chain may be the latest version of the selected document, which is shown in FIG. 8 as the file icon 804 with the filename “file_{—}122.doc.” In some exemplary embodiments, the freshness map 802 and the provenance map 702 may be shown together in a single screen. For example, the freshness map 802 and the provenance map 702 may be shown side-by-side in the same screen or merged together into a single combined map.

It will be appreciated that the provenance of a document and freshness of a document are not merely opposites of each other. Because the tree of ideas is narrower in the past than in the future, identifying past source documents may use less pruning as compared to identifying derivative documents. For example, during the freshness algorithm, derivative documents of certain types may be clubbed into different baskets. For example, a similarity metric may be generated for each pair of documents in the target fine cluster, based on the feature vectors associated with each document. The similarity metric may be used to further limit the number of documents that are considered to be derivative documents. For example, a specified number or percentage of the more similar documents may be identified as derivative documents, while the remaining documents may be ignored.

In some exemplary embodiments, the user may click on the file icons 804 to obtain additional information about the corresponding document. For example, clicking on a file icon 804 may cause the GUI to return to the document information screen 600, wherein information about the newly selected document may be displayed. Upon selecting the “Summary” button 610 shown in FIG. 6, the GUI may display a document summary screen as shown in FIG. 9.

FIG. 9 is a screen shot of a document summary screen for a document analysis GUI, in accordance with an exemplary embodiment of the present invention. The document summary screen 900 may include a summary window 902 that shows the results of a document summary algorithm. The document summary algorithm may analyze the selected document to identify the more representative sentences in the document and add those sentences to a document summary.

To identify the more relevant sentences, the summary algorithm may generate a relevance score for each sentence in the document, based, at least in part, on the representative terms. As discussed above, the clustering algorithm may generate a list of representative terms for each cluster. To generate the relevance score, each of the representative terms may be weighted according to the prevalence of the representative term within the cluster or within the specific document being analyzed. For example, the weight value for each representative term may be computed by counting the number of times the representative term appears in the document. The weighted representative terms may then be used to generate the relevance score for each individual sentence. For each sentence in the document, the summary algorithm may identify representative terms within the sentence. Each time a representative term is identified, the corresponding weight value for that representative term may be added to the relevance score. A high relevance score may indicate that the corresponding sentence includes a relatively large number of the representative terms that occur in the document.

The sentences with the highest relevance scores may be added to the document summary in the same order that they appear in the original document. Furthermore, a number of additional sentences that occur above or below the high relevance score sentences may also be added to the summary to provide additional context for the high relevance score sentences. As shown in FIG. 9, the summary window 902 may include the summary generated by the document summary algorithm.

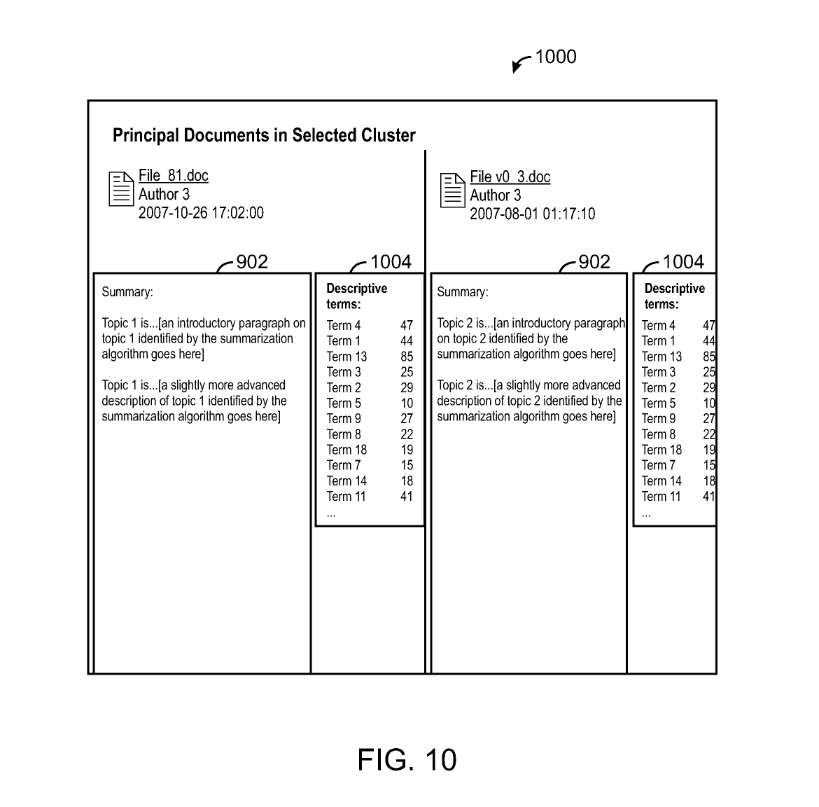

FIG. 10 is a screen shot of a principal documents screen for a document analysis GUI, in accordance with an exemplary embodiment of the present invention. The principal documents screen may be accessed by the user by selecting the “Get Principal Documents” button 510 shown in FIG. 5. The principal documents screen 1000 may include one or more principal document windows 1002 that show one or more documents identified by a principal documents algorithm. The principal documents algorithm may be used to identify a number of high relevance documents in the selected cluster. To identify the high relevance documents, the principal documents algorithm may generate a score for each document in the cluster, based, at least in part, on the representative terms. As discussed above in relation to FIG. 4, the clustering algorithm may generate a list of representative terms for the cluster. Furthermore, as discussed above in relation to FIG. 9, each of the representative terms may be associated with a weight value according to the prevalence of the representative term within the cluster. The weighted representative terms may then be used to generate the score for each individual document in the cluster by identifying the representative terms within the documents. Each time a representative term is identified in a document, the corresponding weight value may be added to the document's score. A high score may indicate that the corresponding document includes a relatively large number of the representative terms that occur in the cluster. The documents may be ranked according to the score, and the highest ranked documents may be added to a list of principal documents.

After generating the list of principal documents, each of the principal documents may be displayed in separate principal document windows 1002. The principal documents window 1002 may display various information about each principal document. For example, the principal document window 1002 may include a summary window 902 and a list 1004 of descriptive terms. The descriptive terms list 1004 may be displayed along with an associated value that describes the number of times the each term occurs in the document. In some exemplary embodiments, the terms in the list 1004 may include some or all of the representative terms generated by the clustering algorithm. In this case, the descriptive terms lists 1004 for each principal document may display the same terms in the same order. For example, the terms may be ordered according to the average number of times that the representative term 410 occurs across all of the documents in the corresponding cluster. In this way, the user may be able to more easily compare the relative term occurrence for each of the principal documents. In other embodiments, the list 1004 may include a list of the more common terms included in the document, regardless of whether the terms have been identified as representative terms by the clustering algorithm. In this case, the terms may be obtained from the feature vector generated for the document by the clustering algorithm. Furthermore, the terms may also be ordered according to the terms prevalence within each document.

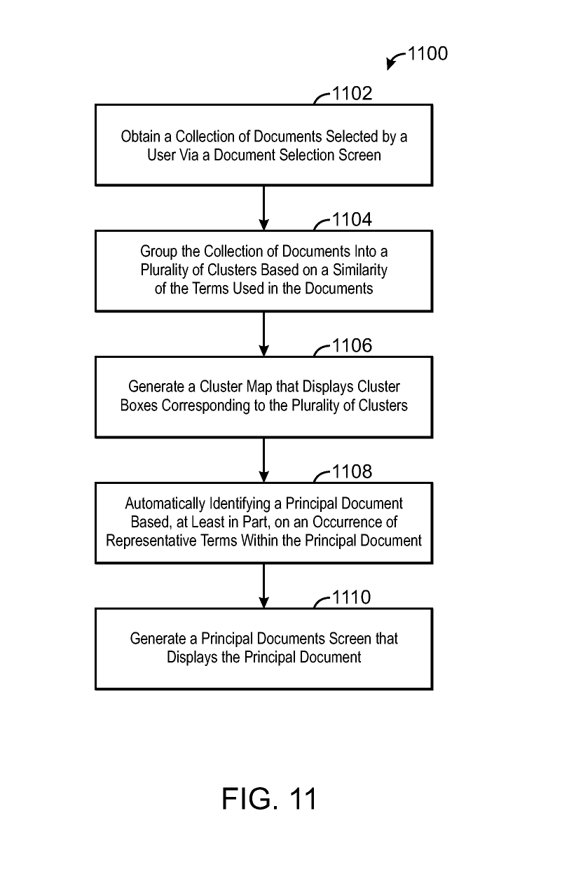

FIG. 11 is a process flow diagram of a method for displaying related groups of documents, in accordance with an exemplary embodiment of the present invention. The method is is generally referred to by the reference number 1100 and begins at block 1102, wherein a collection of documents selected by the user via the document selection screen may be obtained. At block 1104, the collection of documents may be grouped into a plurality of clusters based on a similarity of the terms used in the documents. At block 1106 a cluster map may be generated that displays cluster boxes corresponding to the plurality of clusters. At block 1108 a principal document may be automatically identified based, at least in part, on an occurrence of representative terms within the principal document. As noted above, the representative terms are those terms identified by the clustering algorithm as being more effective for distinguishing between documents that belong to different clusters. At block 1110, a principal documents screen that displays the principal document may be generated.

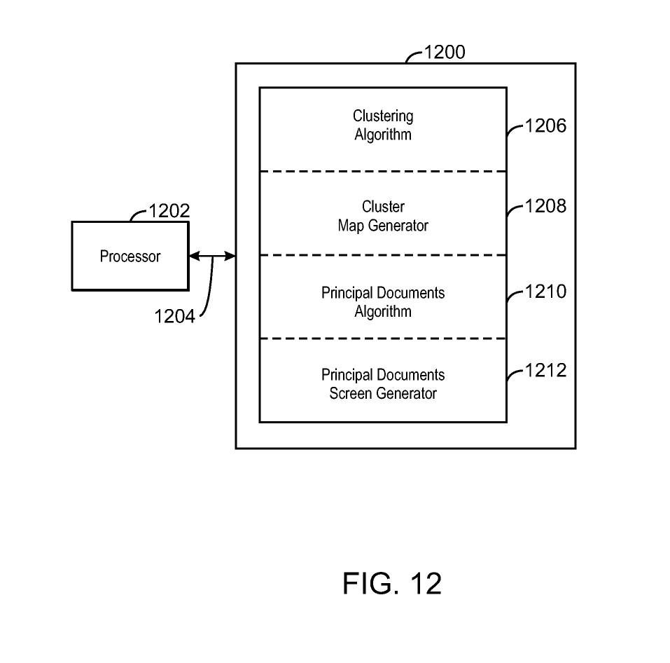

FIG. 12 is a block diagram showing a tangible, machine-readable medium that stores code adapted to generate a document analysis GUI, in accordance with an exemplary embodiment of the present invention. The tangible, machine-readable medium is generally referred to by the reference number 1200. The tangible, machine-readable medium 1200 can comprise RAM, a hard disk drive, an array of hard disk drives, an optical drive, an array of optical drives, a non-volatile memory, a USB drive, a DVD, a CD or the like. In one exemplary embodiment of the present invention, the tangible, machine-readable medium 1200 can be accessed by a processor 1202 over a computer bus 1204.

The various software components discussed herein can be stored on the tangible, machine-readable medium 1200 as indicated in FIG. 12. For example, a first block 1206 on the tangible, machine-readable medium 1200 may store a clustering algorithm configured to receive a collection of documents and group the collection of documents into a plurality of clusters based on a similarity of the terms used in the documents. A second block 1208 can include a cluster map generator configured to generate a cluster map that displays cluster boxes corresponding to the plurality of clusters. A third block 1210 can include a principal documents algorithm configured to identify one or more principal documents based, at least in part, on an occurrence of representative terms within the documents. As noted above, the representative terms are terms have been identified by the clustering algorithm as being more effective for distinguishing between documents that belong to different clusters. A fourth block 1212 can include a principal documents screen generator configured to generate a principal documents screen that displays the principal documents.

Although shown as contiguous blocks, the software components can be stored in any order or configuration. For example, if the tangible, machine-readable medium 1200 is a hard drive, the software components can be stored in non-contiguous, or even overlapping, sectors.

What is claimed is:

1. A computer system, comprising:
a processor that is adapted to execute machine-readable instructions; and
a storage device that is adapted to store data, the data comprising a plurality of documents and instructions that are executable by the processor to generate a graphical user interface (GUI), the GUI comprising:
a cluster map that includes the results of a clustering algorithm applied to the documents; and
a principal documents screen that includes a principal document that is identified by weighting each of the documents in a cluster based, at least in part, on an occurrence of representative terms in the document, wherein the representative terms are terms that have been identified by the clustering algorithm as being more effective for distinguishing between documents that belong to different clusters.

2. The computer system of claim 1, wherein the GUI comprises a cluster map that includes a plurality of cluster boxes, wherein each cluster box corresponds with one of the document clusters generated by the clustering algorithm.

3. The computer system of claim 2, wherein a proximity of the cluster boxes corresponds with a similarity between the clusters, and a size of each of the cluster boxes corresponds with the number of documents included in each corresponding cluster.

4. The computer system of claim 2, wherein the cluster boxes are color coded based, at least on part, on a relevance value computed for each corresponding cluster, and the relevance value is based, at least in part, on the occurrence of specified keywords within the corresponding cluster.

5. The computer system of claim 1, wherein the GUI comprises a cluster description screen that includes a list of the documents included in a cluster.

6. The computer system of claim 5, wherein the cluster description screen includes a list of the representative terms generated by the clustering algorithm.

7. The computer system of claim 1, wherein the GUI comprises a provenance screen that includes an evolutionary chain of a selected document from the selected document origins to the selected document's current state, wherein older documents in the chain have been identified by a provenance algorithm as having contributed content to the selected document.

8. The computer system of claim 7, wherein the provenance screen includes one or more file edits comprising a direct link from a single older document to a single newer document, and one or more file mergers comprising two or more direct links from two or more older documents to another single newer document.

9. The computer system of claim 1, wherein the GUI comprises a freshness screen that includes a chain of newer documents that leads from a selected document to a current state of the selected document, wherein the newer documents have been identified by a freshness algorithm as being derivatives of the selected document.

10. The computer system of claim 1, wherein the GUI comprises a summary screen that includes an automatically generated summary of a selected document.

11. A method of displaying related groups of documents, comprising:
obtaining a collection of documents selected by a user via a document selection screen;
grouping the collection of documents into a plurality of clusters based on a similarity of the terms used in the documents;
generating a cluster map that includes cluster boxes corresponding to the plurality of clusters;
automatically identifying a principal document based, at least in part, on an occurrence of representative terms within the principal document, wherein the representative terms are terms that have been identified as being more effective for distinguishing between documents that belong to different clusters; and
generating a principal documents screen that includes the principal document.

12. The method of claim 11, comprising obtaining one or more keywords selected by a user via the document selection screen and color coding the cluster boxes based, at least in part, on an occurrence of the keywords within the clusters corresponding to the cluster boxes.

13. The method of claim 11, comprising generating an evolutionary chain of a selected document from the selected document origins to the selected document's current state, wherein older documents in the chain have been identified by a provenance algorithm as having contributed content to the selected document.

14. The method of claim 11, comprising generating a chain of newer documents that leads from a selected document to a current state of the selected document, wherein the newer documents have been identified by a freshness algorithm as being derivatives of the selected document.

15. The method of claim 11, comprising generating a summary of a selected document, wherein generating the summary comprises weighting each sentence in the selected document according to the occurrence of the representative terms.

16. A tangible, computer-readable medium, comprising code configured to direct a processor to:
obtain a collection of documents selected by a user;
group the collection of documents into a plurality of clusters based on a similarity of the terms used in the documents;
generate a cluster map that includes cluster boxes corresponding to the plurality of clusters;
identify a principal document based, at least in part, on an occurrence of representative terms within the principal document, wherein the representative terms are terms have been identified by a clustering algorithm as being more effective for distinguishing between documents that belong to different clusters; and
generate a principal documents screen that includes the principal document.

17. The tangible, computer-readable medium of claim 16, comprising code configured to direct the processor to position the cluster boxes in the cluster map, based at least in part, on a similarity between the corresponding clusters.

18. The tangible, computer-readable medium of claim 16, comprising code configured to direct the processor to identify documents within a selected cluster that have contributed to the content of a selected document and generate an evolutionary chain of the selected document from the selected document origins to the selected document's current state.

19. The tangible, computer-readable medium of claim 16, comprising code configured to direct the processor to identify documents within a selected cluster that are derivatives of a selected document and generate a chain of newer documents that leads from the selected document to a current state of the selected document.

20. The tangible, computer-readable medium of claim 16, comprising code configured to direct the processor to weight each sentence in the selected document according to the occurrence of the representative terms within each sentence and group a number of highest weighted sentences into a summary of the selected document.
